(19) United States
(12) Patent Application Publication
(10) Pub. No.: US 2004/0091735 A1
(43) Pub. Date: May 13, 2004

(54) Method for producing evaporator boards

(76) Inventor: Frieder Flamm, Stolberg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/250,610

(22) PCT Filed: Oct. 11, 2001
(86) PCT No.: PCT/EP01/11754

(30) Foreign Application Priority Data
Jan. 8, 2001 (DE) 101 00 526.1

(51) Int. Cl. B32B 15/08

(52) U.S. Cl. 428/626

(57) ABSTRACT

The invention relates to an evaporator plate for a refrigerating machine, comprising coolant channels which are arranged between two sheet metal pieces, one placed on top of the other, as well as a method for producing evaporator plates. In order to be able to produce such evaporator plates in large numbers with few rejects and with a reduction in energy required when compared to conventional production methods, it is proposed according to the invention that the sheet metal pieces which constitute the evaporator plate not be joined by means of a soldering process or a hot-rolling process (pressure welding) as has been the case up to now, but instead, that they be joined by means of an adhesive.

The invention relates to an evaporator plate for a refrigerating machine, comprising coolant channels which are arranged between two sheet metal pieces, one placed on top of the other, as well as a method for producing evaporator plates.

Evaporator plates constitute one component of a refrigerating machine, in which the liquid coolant, taking up heat from the environment, is evaporated. Refrigerating machines are stationary or mobile installations for cooling closed spaces and solid, liquid or gaseous bodies to a temperature below that of the environment.

According to the state of the art, evaporator plates are produced in that galvanized aluminum sheet is first levelled and then cut to the desired size of the evaporator plate. A separating agent, e.g. graphite, as an image of the pattern of channels conveying the coolant in the evaporator plates is applied to the sheet metal pieces which have been cut to size. Subsequently, two plates are placed together and pressed together in the presence of heat in a heating device, so that the two sheets are soldered together. Subsequently, the channel areas which were not soldered together, are inflated in a form tool, for example using nitrogen.

Furthermore, from a brochure of SHOWA ALUMINUM CORPORATION, Osaka, Japan—1993, a so-called roll bond method is known in which the sheets, one placed on top of the other, are not soldered but instead are welded together by hot rolling, and are subsequently cold-rolled to their final thickness. The channel regions, which have been covered which parting agent applied in a screen-printing process to preclude them from being welded together, are inflated by means of compressed air, and subsequently the sheet metal pieces are divided into individual evaporator plates. This method is associated with a disadvantage in that the thickness of the sheet metal changes during hot rolling and during the subsequent cold-rolling step, since these steps directly cause corresponding changes in the length of the sheet metal pieces. This leads to problems which in subsequent process steps cause a high reject rate.

The evaporator plates made according to known methods have to be made from high-grade aluminum (Al 99.5) so as to make it possible to produce the coolant channels.

Based on this state of the art, it is thus the object of the invention to create an evaporator plate which need not necessarily be made of high-grade aluminum to nevertheless be producible in large numbers. Furthermore, it is the object of the invention to propose a method for simple series production of evaporator plates with few rejects, which method at the same time requires less energy and allows more design freedom with regard to the coolant channel geometry.

The invention is based on the idea that the sheet metal pieces which constitute the evaporator plate are not joined by means of a soldering process or a hot-rolling process (pressure welding) as has been the case up to now, but instead, that they are joined by means of an adhesive.

In particular, single-pack or two-pack adhesives are used, which are coolant resistant and which maintain their adhesive properties at least in the temperature range between −30° C. and +40° C. Two-pack polyurethane adhesives and single-pack epoxy resin adhesives as well as temperature-dependent polyurethane and polyamide hot-melt adhesives have been shown to be particularly suitable, with the layer thickness of the adhesive preferably ranging from 0.1 mm to 1.45 mm. The hot-melt adhesives are not applied only after the forming of the channel; instead, they are already applied to the base material of the evaporator plate, said base material being in particular strip-shaped. Strip which has been coated in such a way can be coiled in the same way as uncoated strip, without causing adhesion in the coil. The adhesive effect commences only after the material has been heated to a certain temperature.

Joining the sheet metal by means of an adhesive makes it possible to use sheet metal of final thickness and final strength; a circumstance which is advantageous to the dimensional accuracy of the evaporator plates while at the same time reducing the number of rejects. Energy use for the adhesive technology is considerably reduced compared to that in conventional connection technologies. For area application to the areas to be joined, the adhesive can be rolled on with the use of rollers, or it can be applied with a doctor-blade-like or spatula-like tool. As an alternative to area application, the adhesive can also be sprayed on in paths, wherein the quantity is dosed such that no excess adhesive enters the coolant channels after the joining of the sheet metal to be joined.

If the coolant channels are formed by way of cold forming, in particular by deep drawing or stamping, very good cross-sectional repeating accuracy as well as a flexible arrangement of the coolant channels in the sheet metal pieces of the evaporator plate, which sheet metal pieces are placed one on top of the other, can be achieved, optionally on one side, on both sides or on alternate sides.

Forming the coolant channels by means of deep-drawing or stamping makes it possible to use aluminum alloys during the production of evaporator plates, instead of the high-grade aluminum used up to now. If the tensile strength of the aluminum alloy is at least 200 N/mm², considerable savings in the use of materials can be achieved in the production of such evaporator plates. In spite of the use of sheet metal of lesser thickness, the same resistance to pressure and the same bursting strength of the evaporator plates can be achieved. The following wrought aluminum alloys are for example suitable:

Al Mg 3

Al Mg Si 1, or

Al Cu Mg 1.

The tensile strength of the above-mentioned alloys ranges from 200 N/mm² to 250 N/mm², while their elongation at rupture ranges from 12% to 15%. The use of these alloys makes it possible to use sheet metal of thicknesses below 0.6 mm.

In an advantageous embodiment of the invention, at least those areas of the sheet metal pieces, which areas are to be glued together, are subjected to mechanical and/or thermal surface treatment. Depending on the aluminum alloy used for the sheet metal, and depending on the adhesive used, surface treatment, in particular chromium-free pickling passivation for aluminum, is recommended, with such pickling passivation being applied by the dipping method or spraying method. The oxidation layer generated in this way prevents uncontrolled oxidation of the sheet metal being processed. In addition, or as an alternative, further mechanical and/or thermal surface treatment of the areas to be glued together can be carried out. Mechanical surface treatment (e.g. brushing) removes dirt and roughens the surface, which with some adhesive can have an advantageous effect on the strength of the adhesive connection. Thermal surface treatment degreases the surface.

Depending on the curing conditions and the consistency of the adhesive used, it is expedient if the sheet metal pieces which have been joined and cut to the size of evaporator plates are mechanically fixed in relation to each other until minimum curing of the adhesive has taken place. To prevent blocking a press for too long with an evaporator plate in this process, an interlocking connection which is effective in the plate plane can be generated at several positions evenly distributed on the surface of the evaporator plate by means of clinching, with said interlocking connection maintaining the fixing action necessary for curing the adhesive. The evaporator plates fixed in this way can leave the press immediately, and if required they can pass through a curing oven or they can cure at normal environmental conditions until the required final strength of the adhesive has been achieved.

Depending on the adhesive used, it may be necessary for the sheet metal pieces which were mechanically fixed in this way to be additionally pressed one on top of the other and/or to be heated. To this effect, the plates with elastic intermediate layers are piled to a stack, for subsequent curing for the required time, while being subjected to the pressure of a press and/or to simultaneous temperature action.

After hardening has been completed, any aftertreatment such as for example blanking, bending, edge-forming and painting follows.

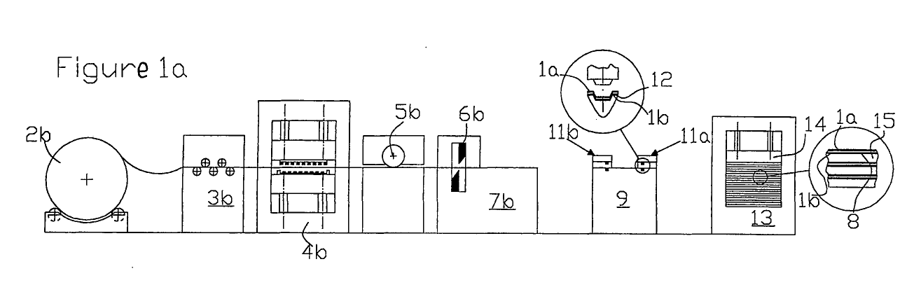

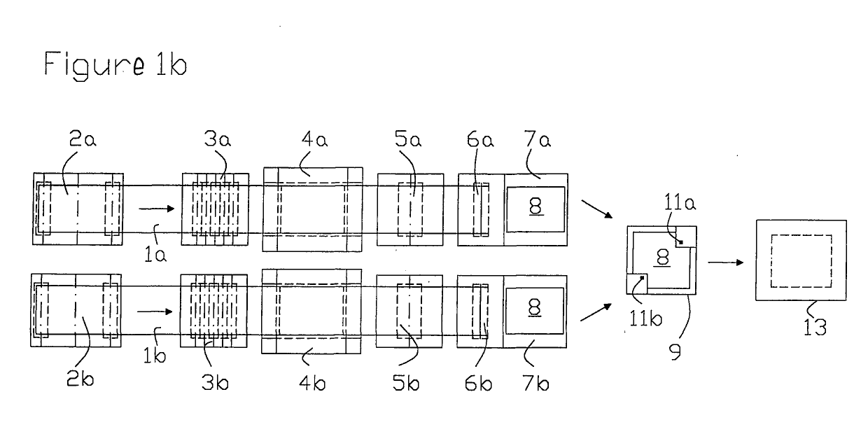

FIGS. 1a and 1b show, in lateral view and in top view, examples of a production line for carrying out the method according to the invention:

The embodiment shows a twin production line in which two sheet metal pieces 1a, 1b are processed in parallel. Having been levelled in roller levelling machines 3a, 3b, the strip-shaped sheet metal pieces 1a, 1b, which have been uncoiled from coils 2a, 2b, are fed to stamping stations 4a, 4b which form the channel pattern for the coolant by means of stamping on both sheet metal pieces. If the coolant channels are to be stamped only on one side, one of the stamping stations 4a or 4b can be omitted; in this case a flat sheet is joined to a stamped sheet.

Subsequently, in both production lines, adhesive is applied using rollers 5a, 5b arranged above the belt run. After the adhesive has been applied, the strip-shaped sheets 1a, 1b are cut to length to the size of the evaporator plate 8, with such cutting taking place by means of shears 6a, 6b in cutting stations 7a, 7b.

In order to prevent a production bottleneck in a press as a result of the adhesive curing, the sheets 1a, 1b which were produced in the two parallel production lines and which were cut to the length of the evaporator plate are joined in a press tool 9, and in two positions 11a, 11b are fixed in relation to each other by means of clinching in an interlocking connection 12, which is effective in the sheet metal plane.

The evaporator plates which have been fixed in this way immediately leave the press tool 9 and are conveyed to a curing station 13 in which they cure in batches until the required final adhesive strength has been reached, with such curing taking place while they are subjected to the pressure of a press 14 and to simultaneous temperature action. Elastic intermediate layers 15, which prevent damage to the coolant channels formed on both sides while in the curing station 13, are located between the curing evaporator plates 8. If the capacity of the curing station 13 cannot handle all the evaporators 8 which can be produced from the two coils 2a, 2b, several curing stations can be provided so as to ensure a continuous production flow.

Transport of the sheet metal 1a, 1b between the cutting stations 7a, 7b, the press tool 9 and the curing station 13 advantageously takes place automatically, for example by way of conveyor means and clock-pulsed gripper devices and lifting devices (for the sake of clarity not shown in the Figures).

List of Reference Characters

| No. | Designation |
|---|---|
| 1.a, b | Sheet metal |
| 2.a, b | Coil |
| 3.a, b | Roller levelling machine |
| 4.a, b | Stamping station |
| 5.a, b | Roller |
| 6.a, b | Shears |
| 7.a, b | Cutting stations |
| 8. | Evaporator plate |
| 9. | Press tool |
| 10. | — |
| 11.a, b | Positions |
| 12. | Interlocking connection |
| 13. | Curing station |
| 14. | Press |
| 15. | Elastic intermediate layers |

1. An evaporator plate for a refrigerating machine, comprising coolant channels which are arranged between two sheet metal pieces, one placed on top of the other, characterised in that the sheet metal pieces (1a, 1b) are joined by means of an adhesive.

2. The evaporator plate according to claim 1, characterised in that the adhesive surfaces of the sheet metal pieces are surface-treated.

3. The evaporator plate according to claim 1 or 2, characterised in that the adhesive is a two-pack polyurethane adhesive or a single-pack epoxy resin adhesive.

4. The evaporator plate according to any one of claims 1 to 3, characterised in that the material of the sheet metal pieces (1a, 1b) is an aluminum alloy with a tensile strength of at least 200 N/mm².

5. The evaporator plate according to any one of claims 1 to 4, characterised in that the sheet metal pieces (1a, 1b) comprise cold-formed coolant channels.

6. A method for producing evaporator plates, in particular according to claims 1 to 5, comprising two sheet metal (1a, 1b), wherein the channel pattern for the coolant is formed into at least one of the sheet metal pieces (1a), characterised in that the two sheet metal pieces (1a, 1b) are joined by means of an adhesive.

7. The method for producing evaporator plates according to claim 6, characterised in that for joining, an adhesive is used which is coolant resistant and which maintains its adhesive properties at least in the temperature range between −30° C. and +40° C.

8. The method for producing evaporator plates according to claim 6 or 7, characterised in that after levelling the sheet metal pieces (1a, 1b) to be joined, the channel pattern for the coolant is formed in at least one of the two sheet metal pieces (1a) by means of deep-drawing.

9. The method for producing evaporator plates according to claim 6 or 7, characterised in that after levelling the sheet metal pieces (1a, 1b) to be joined, the channel pattern for the coolant is formed in at least one of the two sheet metal pieces (1a) by means of stamping.

10. The method for producing evaporator plates according to any one of claims 6 to 9, characterised in that the sheet metal pieces (1a, 1b) are cut to the size of evaporator plates, either before or after application of the adhesive.

11. The method for producing evaporator plates according to any one of claim 6 to 10, characterised in that before the channel pattern for the coolant is formed over the area of at least one sheet metal piece (1a, 1b), a temperature-dependent adhesive is applied over the area of at least one (1a) of the two sheet metal pieces, wherein the adhesive effect of the temperature-dependent adhesive commences only after the adhesive has been heated to a defined temperature.

12. The method for producing evaporator plates according to any one of claims 6 to 11, characterised in that at least those areas of the sheet metal pieces (1a, 1b) which are to be glued together are subjected to mechanical and/or thermal surface treatment.

13. The method for producing evaporator plates according to any one of claim 6 to 12, characterised in that the sheet metal pieces which have been joined and cut to the size of evaporator plates are fixed in relation to each other until minimum curing of the adhesive has taken place.

14. The method for producing evaporator plates according to claim 13, characterised in that the sheet metal pieces which were mechanically fixed are additionally pressed one on top of the other and/or are heated.
